(19) United States
(12) Patent Application Publication
(10) Pub. No.: US 2026/0348347 A1
(43) Pub. Date: Nov. 5, 2026

(54) FUEL RAIL FOR FUEL SYSTEM OF AN INTERNAL COMBUSTION ENGINE

(71) Applicant: Cummins-Scania HPCR System, LLC, Columbus, IN (US)

(72) Inventors: Animesh Nandy, Burdwan (IN); Wilber Beale Delano, JR., Columbus, IN (US); Santos Burrola Marrufo, Columbus, IN (US)

(21) Appl. No.: 19/655,256

(22) Filed: Apr. 22, 2026

(30) Foreign Application Priority Data
May 2, 2025 (IN) 202541042652

(51) Int. Cl. F02M 55/02

(52) U.S. Cl. CPC F02M 55/025

(57) ABSTRACT

A fuel rail for a fuel system includes a single, monolithic rail body extending from a first end to a second end opposite the inlet end. The first end is configured for engagement to a high pressure fuel line. A flow passage extends from the second end to an end wall within the fuel rail and a first end passage extends from the first end through the end wall to the flow passage.

### TECHNICAL FIELD

The present application relates to internal combustion engines, and more particularly to fuel rails for fuel systems of internal combustion engines.

### BACKGROUND

Fuel leakage can cause undesirable operation internal combustion engines. Identifying and repairing components in fuel systems that are causing leakage can be difficult, time consuming, and expensive. Therefore, fuel system components that are robust and resistant to fuel leakage are desirable. As a result, there remains a significant unmet need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and method of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

One embodiment is a unique fuel rail for a fuel system of an internal combustion engine. Another embodiment is a unique method for fabricating a fuel rail for a fuel system of an internal combustion engine. Another embodiment is a unique fuel rail made according to a unique method. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example system including an internal combustion engine and a fuel system with a fuel rail according to the present disclosure.

FIG. 2 is a longitudinal section view of a fuel rail of the fuel system of FIG. 1 according to an example embodiment of the present disclosure.

FIG. 3 is an enlarged view of a first end of the fuel rail of FIG. 2.

FIG. 4 is a longitudinal section view showing a portion of a flow passage formed in the fuel rail of FIG. 2 from a second end of the fuel rail opposite the first end toward first end.

FIG. 5 is a perspective view showing the first end passage formed through the first end of the fuel rail to the flow passage formed in FIG. 4.

### DETAILED DESCRIPTION OF EXAMPLE EMBODIMENTS

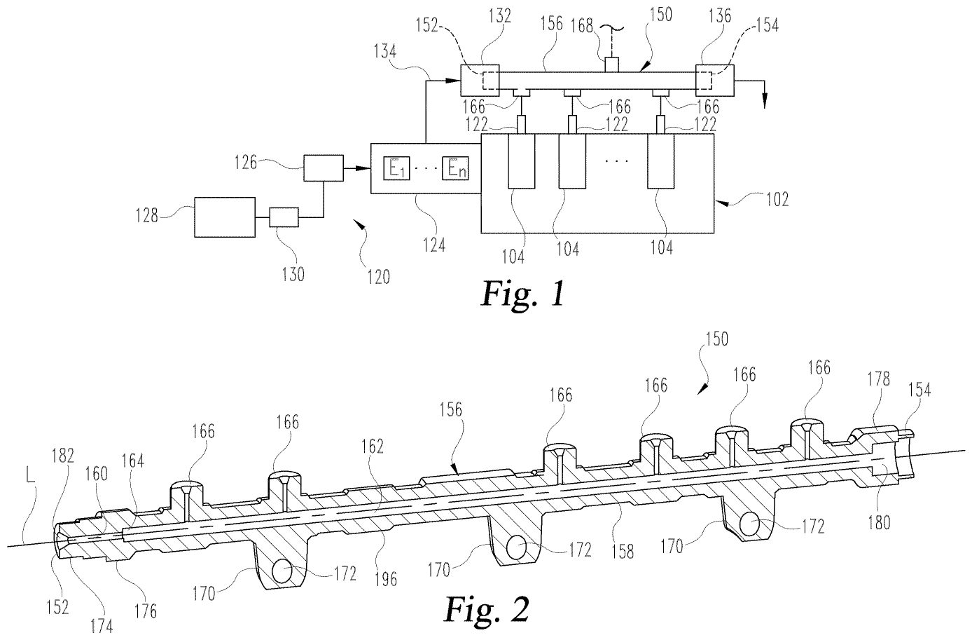

With reference to FIG. 1, there is illustrated a system 100 including an internal combustion engine 102 (also referred to herein as “engine 102”) and a fuel system 120 operatively coupled with engine 102. In the illustrated embodiment engine 102 is a direct-injection, reciprocating piston-type internal combustion engine configured and operable to combust fuel injected by one or more fuel injectors 122 of fuel system 120 directly into one respective ones of a plurality of combustion cylinders 104. It shall be appreciated that engine 102 may be configured and provided in various forms including various numbers of combustion cylinders 104 and various numbers and/or types of fuel injectors 122, including port injectors.

In the illustrated embodiment, fuel system 120 is configured and provided as a high-pressure common-rail (HPCR) fuel system. Fuel system 120 includes a fuel rail 150 which receives pressurized fuel from a fuel pump 124 and distributes pressurized fuel to fuel injectors 122. In the illustrated embodiment, fuel pump 124 is provided and configured as a high pressure fuel pump and includes one or more pump elements (E1 . . . En) such as piston-in-cylinder-type pump elements configured to pressurize fuel received by fuel pump 124. However, any type of fuel pump 124 is contemplated.

In an embodiment, a flow control valve 126, such as an inlet metering valve, an active inlet metering valve, or other type of metering valve, is provided at or upstream from an inlet to fuel pump 124 and is operatively coupled with and controllable by, for example, an engine control unit (not shown) to meter or regulate flow of fuel into fuel pump 106. Flow control valve 126 is configured and operable to receive fuel pumped from fuel tank 128 by pump 130, which may be configured and provided as a low pressure fuel pump. Fuel pump 124 and flow control valve 126 may be configured such that the amount of fuel flow provided by flow control valve 126 can maintain a desired pressure in one or more components of fuel system 120, such fuel injectors 122 and/or fuel rail 150.

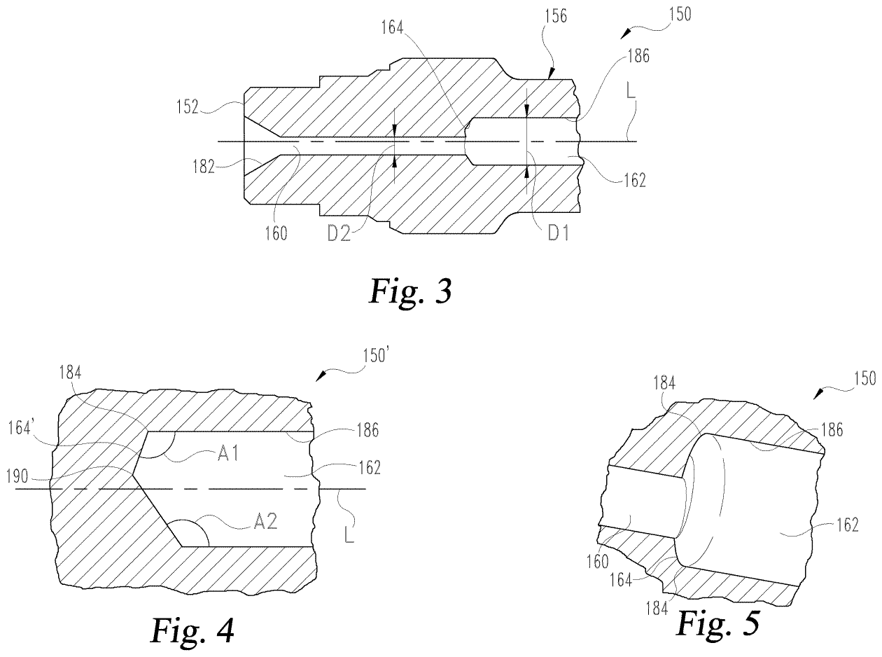

Referring further to FIGS. 2-5, fuel rail 150 includes a first end 152 which receives high pressure fuel from fuel pump 124. Fuel rail 150 include a rail body 156 that extends from first end 152 to an opposite second end 154. Rail body 156 is a single one-piece, monolithic component from first end 152 to second end 154 such that there is no fitting or other separate component engaged to rail body that forms first end 152 of fuel rail 150. Elimination of any such fitting or separate component removes a potential leakage location within fuel system 120.

Rail body 156 includes an elongated, longitudinal portion 158 extending along a central longitudinal axis L. Longitudinal portion 158 includes a first end passage 160 extending therein from first end 152, and a flow passage 162 extending therein from second end 154. In an embodiment, central longitudinal axis L is centered along flow passage 162. First end passage 160 intersects flow passage 162 at an end wall 164 located within rail body 156 adjacent to and downstream of first end 152.

First end 152 can be an inlet end, an outlet end, a plugged end, and/or a sensor end. In an embodiment, first end 152 is configured for engagement with a fuel system component, such as a high pressure fuel line that provides fuel to or receives fuel from first end passage 160. Rail body 156 includes a configuration at first end 152 that is engageable to engage the fuel system component. For example, a tube fitting 132 can be provided that couples at least one high pressure fuel line to fuel rail 150. Other embodiments contemplate a high pressure fuel line coupled at first end 152 along and nominally parallel to longitudinal axis L and/or other types of fuel system components, such as fittings, plugs, sensors, and the like.

In the illustrated embodiment, rail body 156 includes external threads 174 adjacent first end 152 that threadingly engage the fuel system component, such as a tube nut of tube fitting 132, which can be positioned around a high pressure fuel line 134 that is to be coupled in flow communication with first end passage 160 of fuel rail 150. Rail body 156 may also include an outer tool engaging surface 176 around longitudinal portion 158, such as hexagonally-shaped surface or other outer shape, that allows a tool to engage and hold fuel rail 150 during installation.

Flow passage 162 extends from first end passage 160 through second end 154. In another embodiment, second end 154 includes a flow passage portion through second end 154 with a reduced diameter relative to flow passage 162, similar to first end passage 160. In still other embodiments, flow passage 162 includes a size that is the same or similar to first end passage 160. Longitudinal portion 158 of rail body 156 includes an enlarged connecting portion 178 at second end 154. Flow passage 162 includes a widened part 180 in connecting portion 178. Connecting portion 178 is configured, for example, with internal threads, outer threads, or other structure configured to be engaged to a dump or pressure release valve 136, which is operable to return excess fuel back to fuel system 120 from fuel rail 150 when opened. In other embodiments, dump valve 136 is remote from second end 154, and is connected to second end 154 with a fuel line coupled to connecting portion 178.

Flow passage 162 is in fluid communication with a plurality of injector ports 166 that project outwardly from longitudinal portion 158 and define flow paths for fuel to flow to the connected fuel injectors 122. Although six injector ports 166 are shown in the illustrated embodiment, fuel rail 150 can include any number of injector ports 166, depending on the number of fuel injectors 122 to be connected. At least one sensor port 168 may also be provided, such as at boss 196 of longitudinal portion 158, that is in fluid communication with flow passage 162. Rail body 156 also includes a plurality of mounting tabs 170 projecting laterally outwardly from longitudinal portion 158. Mounting tabs 170 each include a hole 172 configured to receive a fastener to secure fuel rail 150 in position, such as to a cylinder head or other engine component.

Along injector ports 166, flow passage 162 includes a first cross-sectional area or dimension D1 orthogonal to central longitudinal axis L, while first end passage 160 includes a second cross-sectional area or dimension D2 orthogonal to central longitudinal axis L. The outer end of first end passage 160 includes a flared end passage portion 182 that extends from the first end 152 along a part of a length of the first end passage 160. In an embodiment, dimensions D1 and D2 are diameters and first end passage 160 and flow passage 162 have circular cross-sections. However, other shapes are not precluded.

First end passage 160 extends through end wall 164 and opens into flow passage 162. In an embodiment, first end passage 160 is eccentric relative to flow passage 162. For example, flow passage 162 can be centered along central longitudinal axis L, while first end passage 160 is offset from central longitudinal axis L. In another embodiment, first end passage 160 is concentric with flow passage 162, and both are either centered on central longitudinal axis L or offset from central longitudinal axis L.

In an embodiment, flow passage 162 is formed by gun drilling through longitudinal portion 158 of a rail body 156, which is provided as a solid metal one-piece monolithic material. Flow passage 162 is drilled into longitudinal portion 158 to form a blind end wall 164′ at that point in the fabrication process. First end passage 160 is then formed through first end 152 to pierce the blind end wall 164′ to fluidly connect first end 152 to flow passage 162, modifying blind end wall 164′ to form end wall 164.

In an embodiment, flow passage 162 is formed with a fillet 184 between a longitudinal wall 186 extending along and defining flow passage 162 and blind end wall 164′. The fillet 184 provides a curved transition between blind end wall 164′ and longitudinal wall 186. In a specific embodiment, fillet 184 is about 50 microns. Other embodiments contemplate other sizes for fillet 184 and/or non-curved fillets.

In an embodiment, flow passage 162 is formed so that the blind end wall 164′ has a concave shape with a vertex 190 offset from central longitudinal axis L. In an embodiment, blind end wall 164′ has a first angular orientation A1 between longitudinal wall 186 along a first side of flow passage 162 and a second angular orientation A2 between longitudinal wall 186 and blind end wall 164′ along a second side of flow passage 162 opposite the first side. Since first end passage 160 is smaller than flow passage 162, fillet 184 and the angular orientations A1 and A2 are also present between end wall 164 and longitudinal wall 186 after formation of first end passage 160. Vertex 190, however, may or may not be removed when first end passage 160 pierces blind end wall 164′.

In an embodiment, a method of fabricating fuel rail 150 includes forming flow passage 162 through a solid fuel rail body 156 to form blind end wall 164′ located within fuel rail 150. Flow passage 162 is formed through second end 154 of fuel rail 150 toward opposite first end 152 of fuel rail 150 to the blind end wall 164′. The method further includes forming first end passage 160 through the opposite first end 152 and through the blind end wall 164′ to flow passage 162.

In an embodiment, first end passage 160 is formed eccentrically with flow passage 162. In an embodiment, first end passage 160 is formed with flared inlet passage portion 182 extending from first end 152 along a part of a length of first end passage 160. In an embodiment, flow passage 162 is formed with a first cross-sectional area or dimension D1 and first end passage 160 is formed with a second cross-sectional area or dimension D2 that is less than the first cross-sectional area or dimension D1.

In an embodiment, flow passage 162 is formed along central longitudinal axis L to form a blind end wall 164′ to include a concave shape having vertex 190 that is offset from central longitudinal axis L. In an embodiment, flow passage 162 is formed to include fillet 184 between longitudinal wall 186 of flow passage 162 and blind end wall 164′.

In an embodiment, blind end wall 164′ is formed to have a concave shape with first angular orientation A1 between longitudinal wall 186 and blind end wall 164′ along a first side of flow passage 162 and a second angular orientation A2 between longitudinal wall 186 and the blind end wall 164′ along a second side of flow passage 162 opposite the first side.

In an embodiment, fuel rail 150 is fabricated entirely from a solid forged fuel rail body 156 that is a one-piece monolithic body of metal material. In an embodiment, fuel rail 150 is a one-piece monolithic rail body 156 extending from first end 152 to second end 154 opposite first end 152. In other embodiments, rail body 156 is a one-piece monolithic rail body 156 formed from a billet of material and/or by being drawn over a mandrel tubing where the operation stops at a blind end.

First end 152 is configured for direct engagement to a high pressure fuel line, plug, sensor, and/or tube nut of tube fitting 132 without an intervening fitting, and fuel rail 150 is fabricated by forming flow passage 162 through second end 154 of solid fuel rail body 156 to form blind end wall 164′ located within fuel rail 150 and then forming first end passage 160 through first end 152 and through the blind end wall 164′ to flow passage 162 to form end wall 164.

Various aspects and embodiments of the present application are contemplated herein. For example, one aspect is directed to a method of fabricating a fuel rail. The method includes forming a flow passage through a solid one-piece fuel rail body to a blind end wall located within the fuel rail, the flow passage being formed through one end, or second end 154, of the fuel rail toward an opposite other end, or first end 152, of the fuel rail to the blind end wall; and forming an end passage through the opposite other end and through the blind end wall to the flow passage.

In an embodiment of the method, forming the end passage includes forming the end passage eccentrically with the flow passage.

In an embodiment of the method, forming the end passage includes forming the end passage with a flared end passage portion extending from the other end along a part of a length of the end passage.

In an embodiment of the method, forming the flow passage includes forming the flow passage with a first cross-sectional area; and forming the end passage includes forming the end passage with a second cross-sectional area that is less than the first cross-sectional area.

In an embodiment of the method, forming the flow passage includes forming the flow passage along a central longitudinal axis; and forming the flow passage includes forming the blind end wall to include a concave shape having a vertex that is offset from the central longitudinal axis.

In an embodiment of the method, forming the flow passage includes forming the blind end wall with a fillet between a longitudinal wall of the flow passage and the blind end wall.

In an embodiment of the method, forming the flow passage includes forming the blind end wall having a concave shape with a first angular orientation between the longitudinal wall and the blind end wall along a first side of the flow passage and a second angular orientation between the longitudinal wall and the blind end wall along a second side of the flow passage opposite the first side.

In an embodiment, the method includes forming threads around the fuel rail at the other end for connection with a tube nut of a high pressure fuel line.

In an embodiment of the method, the fuel rail body is a solid forged rail body that is a monolithic piece of metal material.

According to another aspect of the disclosure, a fuel rail for a fuel system us provided. The fuel rail includes a one-piece, monolithic rail body extending from a first end to a second end opposite the first end. The first end is configured for engagement to a fuel system component. The fuel rail is fabricated by forming a flow passage through a one-piece fuel rail body to a blind end wall located within the fuel rail, the flow passage being formed through the second end of the fuel rail toward the opposite first end of the fuel rail to the blind end wall; and forming a first end passage through the first end and through the blind end wall to the flow passage.

Another aspect of the present disclosure is directed to a fuel rail for a fuel system. The fuel rail includes a single, monolithic rail body extending from a first end to an opposite second end. The rail body includes a flow passage extending through the second end to an end wall located within the rail body. The rail body further includes a first end passage extending through the first end through the end wall.

In an embodiment of the fuel rail, the rail body includes external threads at the first end. The external threads are configured for engagement with a tube nut of a high pressure fuel line.

In an embodiment of the fuel rail, the second end is configured for engagement with a dump valve.

In an embodiment of the fuel rail, the first end passage is eccentric to the flow passage.

In an embodiment of the fuel rail, the end wall has a concave shape with a first angular orientation between the longitudinal wall and the end wall along a first side of the flow passage and a second angular orientation between the longitudinal wall and the end wall along a second side of the flow passage opposite the first side.

In an embodiment of the fuel rail, a fillet extends between the longitudinal wall of the flow passage and the end wall.

In an embodiment of the fuel rail, flow passage has a first cross-sectional area, the first end passage includes a second cross-sectional area, and the second cross-sectional area is less than the first cross-sectional area.

In an embodiment, the fuel rail includes a plurality of fuel injector ports extending through the rail body to the flow passage in a transverse orientation to the flow passage.

In an embodiment, the fuel rail includes a plurality of mounting tabs extending outwardly from a longitudinal portion of the rail body. Each of the mounting tabs includes a hole for a fastener.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of fabricating a fuel rail, the method comprising:
forming a flow passage through a one-piece fuel rail body to a blind end wall located within the fuel rail, the flow passage being formed through one end of the fuel rail toward an opposite other end of the fuel rail to the blind end wall; and
forming an end passage through the opposite other end and through the blind end wall to the flow passage.

2. The method according to claim 1, wherein forming the end passage includes forming the end passage eccentrically with the flow passage.

3. The method according to claim 1, wherein forming the end passage includes forming the end passage with a flared end passage portion extending from the other end along a part of a length of the end passage.

4. The method according to claim 1, wherein:
forming the flow passage includes forming the flow passage with a first cross-sectional area; and
forming the end passage includes forming the end passage with a second cross-sectional area that is less than the first cross-sectional area.

5. The method according to claim 1, wherein:
forming the flow passage includes forming the flow passage along a central longitudinal axis; and
forming the flow passage includes forming the blind end wall to include a concave shape having a vertex that is offset from the central longitudinal axis.

6. The method according to claim 1, wherein forming the flow passage includes forming the blind end wall with a fillet between a longitudinal wall of the flow passage and the blind end wall.

7. The method according to claim 6, wherein forming the flow passage includes forming the blind end wall having a concave shape with a first angular orientation between the longitudinal wall and the blind end wall along a first side of the flow passage and a second angular orientation between the longitudinal wall and the blind end wall along a second side of the flow passage opposite the first side.

8. The method according to claim 1, comprising forming threads around the fuel rail at the other end for connection with a tube nut of a high pressure fuel line.

9. The method according to claim 1, wherein the one-piece fuel rail body is a solid forged rail body that is a monolithic piece of metal material.

10. A fuel rail for a fuel system, the fuel rail comprising a single, monolithic rail body extending from a first end to a second end opposite the inlet end, the first end configured for engagement to a high pressure fuel line, wherein the fuel rail is fabricated according to the method comprising:
forming a flow passage through a one-piece fuel rail body to a blind end wall located within the fuel rail, the flow passage being formed through one end of the fuel rail toward an opposite other end of the fuel rail to the blind end wall; and
forming an end passage through the opposite other end and through the blind end wall to the flow passage.

11. The fuel rail according to claim 10, wherein forming the end passage includes forming the end passage eccentrically with the flow passage.

12. A fuel rail for a fuel system, the fuel rail comprising:
a single, monolithic rail body extending from a first end to an opposite second end, the rail body including a flow passage extending through the second end to an end wall located within the rail body, the rail body further including a first end passage extending through the first end through the end wall.

13. The fuel rail according to claim 12, wherein the rail body includes external threads at the first end, the external threads configured for engagement with a fuel system component.

14. The fuel rail according to claim 13, wherein the second end is configured for engagement with a dump valve.

15. The fuel rail according to claim 12, wherein the first end passage is eccentric to the flow passage.

16. The fuel rail according to claim 12, wherein the end wall has a concave shape with a first angular orientation between the longitudinal wall and the end wall along a first side of the flow passage and a second angular orientation between the longitudinal wall and the end wall along a second side of the flow passage opposite the first side.

17. The fuel rail according to claim 12, comprising a fillet between the longitudinal wall of the flow passage and the end wall.

18. The fuel rail according to claim 12, wherein the flow passage has a first cross-sectional area, the first end passage includes a second cross-sectional area, and the second cross-sectional area is less than the first cross-sectional area.

19. The fuel rail according to claim 12, comprising a plurality of fuel injector ports extending through the rail body to the flow passage in a transverse orientation to the flow passage.

20. The fuel rail according to claim 12, comprising a plurality of mounting tabs extending outwardly from a longitudinal portion of the rail body, each of the mounting tabs including a hole for a fastener.
